(19) United States
(12) Patent Application Publication
(10) Pub. No.: US 2012/0112754 A1
(43) Pub. Date: May 10, 2012

(54) APPARATUS QUANTIFYING STATE-OF-CHARGE OF VEHICLE-MOUNTED RECHARGEABLE BATTERY

(75) Inventor: Toshiyuki KAWAI, Toyohashi-shi (JP)

(73) Assignee: DENSO CORPORATION, Kariya-city (JP)

(21) Appl. No.: 13/293,313

(22) Filed: Nov. 10, 2011

(30) Foreign Application Priority Data
Nov. 10, 2010 (JP) 2010-252260

(51) Int. Cl. G01N 27/416

(52) U.S. Cl. 324/428; 324/427

(57) ABSTRACT

A rechargeable battery state-of-charge quantifying apparatus for use in a vehicle equipped with an electric motor and a rechargeable battery which supplies electric power to the motor to produce a driving torque. The apparatus quantifies a state-of-charge of the rechargeable battery and defines a minimum value of a state-of-charge of the rechargeable battery at which the rechargeable battery is permitted to produce a degree of electric power required to run the vehicle as a lower limit. The lower limit is increased as the rechargeable battery ages, thereby ensuring the stability in supplying the amount of electric power to the motor which is required to run the vehicle regardless of aging of the battery.

### CROSS REFERENCE TO RELATED DOCUMENT

The present application claims the benefit of priority of Japanese Patent Application No. 2010-252260 filed on Nov. 10, 2010, the disclosure of which is incorporated herein by reference.

### BACKGROUND OF THE INVENTION

1. Technical Field

The present disclosure relates generally to an apparatus designed to quantify the state-of-charge of a rechargeable battery (also called a secondary battery) mounted in an automotive vehicle equipped with an electric rotating machine powered by the secondary battery to operate as a main drive source.

2. Background Art

Automotive vehicles equipped with an electric rotating machine (e.g., an electric motor) working as a main drive source and a rechargeable battery for supplying electric power to the electric rotating machine are usually required to manage the state-of-charge (SOC) of the battery accurately. Japanese Patent First Publication No. 2007-147487 teaches estimation of a maximum dischargeable electric power based on a maximum dischargeable amount of current and a given lower voltage limit of the rechargeable battery. The maximum dischargeable amount of current is the amount of electric current which is to be discharged for a period of time until after a terminal voltage at the rechargeable battery reaches the lower voltage limit.

In recent years, electric vehicles equipped with only an electric rotating machine as a drive engine or plug-in hybrid vehicles equipped with an internal combustion engine working as a drive engine and a rechargeable battery that can be restored to full charge by connecting a plug to an external commercial electric power source have been put into commercial use, Inventors of this application have found that it is essential for these type of vehicles to quantify the state-of-charge of the rechargeable battery for determining whether the rechargeable battery to can supply an amount of electric power required by the electric rotating machine or not.

### SUMMARY

It is therefore an object to provide a rechargeable battery state-of-charge quantifying apparatus which is used with a vehicle equipped with an electric rotating machine working as a main drive source and a rechargeable battery supplying electric power to the electric rotating machine and quantifies a state-of-charge of the rechargeable battery in a desired manner.

According to one aspect of an embodiment, there is provided a rechargeable battery state-of-charge quantifying apparatus for use in a vehicle equipped with an electric rotating machine working as a drive source and a rechargeable battery serving to supply electric power to the electric rotating machine, The rechargeable battery state-of-charge quantifying apparatus comprises: (a) quantifying means for quantifying a state-of-charge of the rechargeable battery, said quantifying means defining a minimum value of a state-of-charge of the rechargeable battery at which the rechargeable battery is permitted to produce electric power required to run the vehicle as a lower limit; and (b) increasing means for increasing the lower limit as the rechargeable battery ages.

Generally, as the rechargeable battery is aged, the ter urinal voltage thereof drops with no relation to the amount of electric power discharged therefrom. Additionally, the amount by which the ib state-of-charge of the rechargeable battery drops will increase with the aging thereof regardless of the amount of energy discharged therefrom. In order to compensate for such an increase in drop in the state-of-charge, the rechargeable battery state-of-charge quantifying apparatus increases the lower limit at which the rechargeable battery is permitted to supply the power to the electric rotating machine which is required to run the vehicle with the aging of the rechargeable battery. The increase in lower limit will result in an increase in open-circuit voltage at the rechargeable battery, which leads to an increase in lower limit of the terminal voltage at the rechargeable battery when discharged and also an increase in lower limit of the state-of-charge when the state-of-charge is decreased upon discharging of the rechargeable battery. This enables the electric power to be supplied from the rechargeable battery to the electric rotating machine to ensure the traveling of the vehicle regardless of the aging of the rechargeable battery and also permits the amount of electric power or the electric power discharged from the rechargeable battery to be increased before the rechargeable battery ages, as compared with when the lower limit of the state-of-charge is determined initially so as to compensate for a change in the lower limit resulting from the aging of the rechargeable battery.

In the preferred mode of the embodiment, the lower limit is a minimum of the state-of-charge of the rechargeable battery at which the electric rotating machine is permitted to provide a drive force for the vehicle to ensure a given traveling performance of the vehicle. According to another aspect of the embodiment, there is provided a rechargeable battery state-of-charge quantifying apparatus for use in a vehicle equipped with an electric rotating machine working as a drive source and a rechargeable battery serving to supply electric power to the electric rotating machine. The rechargeable battery state-of-charge quantifying apparatus comprises: (a) quantifying means for quantifying a state-of-charge of the rechargeable battery, said quantifying means defining a minimum value of the state-of-charge of the rechargeable battery at which the rechargeable battery is permitted to produce a degree of electric power required to run the vehicle as a lower limit; and (b) changing means for changing the lower limit as a function of a temperature of the rechargeable battery.

Generally, a change in temperature of the rechargeable battery will result in a change in internal resistance thereof, which leads to a change in drop in terminal voltage at the rechargeable battery regardless of the amount of energy discharged therefrom. In order to compensate for such a change in drop in the terminal voltage, the rechargeable battery state-of-charge quantifying apparatus is designed to increase the lower limit at which the rechargeable battery is permitted to supply the power to the electric rotating machine which is required to run the vehicle as a function of the temperature of the rechargeable battery. Thus, when the drop in terminal voltage increases, the lower limit of the state-of-charge will increase. This enables the electric power to be supplied to the electric rotating machine which is required to run the vehicle and also permits the amount of electric power or the electric power discharged from the rechargeable battery to be increased, as compared with when the lower limit of the state-of-charge is determined initially based on the temperature of the rechargeable battery at which the drop in terminal voltage would be maximized.

The lower limit may be increased with a decrease in temperature of the rechargeable battery.

Each of the rechargeable battery state-of-charge quantifying apparatus, as described above, may include an informing device which, when an actual value of the state-of-charge reaches the lower limit, informs, for example, a vehicle driver of such an event.

The informing device may be designed to indicate the degree to which the actual value of the state-of-charge is greater than the lower limit. This enables the driver to perceive the amount of energy available from the rechargeable battery.

The increasing means of each of the rechargeable battery state-of-charge quantifying apparatuses may include a calculator which calculates the lower limit of the rechargeable battery which produces the electric power required to run the vehicle based on the state of aging of the rechargeable battery.

The calculator may determine the lower limit by simulating a state of the rechargeable battery when the rechargeable battery is discharged from a value of the state-of-charge which is smaller than a current value of the state-of-charge.

The simulation of the state of the rechargeable battery from the value of the state-of-charge which is smaller than the current value thereof enables the lower limit of the state-of-charge correctly before the operating condition of the rechargeable battery changes.

The calculator may determine the lower limit by simulating the state of the rechargeable battery when the rechargeable battery is discharged from each of different values of the state-of-charge which are smaller than the current value of the state-of-charge.

This results in an increase in accuracy in determining the lower limit of the state-of-charge.

According to the third aspect of the embodiment, there is provided a rechargeable battery state-of-charge quantifying apparatus for use in a vehicle equipped with an electric rotating machine working as a drive source and a rechargeable battery serving to supply electric power to the electric rotating machine. The rechargeable battery state-of-charge quantifying apparatus comprises: (a) quantifying means for quantifying a state-of-charge of the rechargeable battery; and (b) a calculator which simulates a state of the rechargeable battery when the rechargeable battery is charged or discharged in a value of the state-of-charge which is temporarily set to be different from a current value of the state-of-charge based on a state of aging of the rechargeable battery to calculate a threshold value of the state-of-charge required to run the vehicle.

Generally, as the rechargeable battery is aged, the terminal voltage thereof drops with no relation to the amount of electric power discharged therefrom. Additionally, a drop in state-of-charge of the rechargeable battery will increase with the aging thereof regardless of the amount of energy discharged therefrom. The rechargeable battery state-of-charge quantifying apparatus simulates a change in state of the rechargeable battery when charged or discharged in the current value of the state-of-charge to calculate the threshold value of the state-of-charge of the rechargeable battery when charged or discharged to produce the electric power required to run the vehicle. The threshold value is, therefore, determined as a function of aging of the rechargeable battery, thus ensuring the stability in charging or discharging the rechargeable battery to produce the electric power for running the vehicle. This also permits the amount of electric power or the level of electric power to be charged into or discharged from the rechargeable battery to be increased during the overall lifetime of the rechargeable battery, as compared with when the threshold value of the state-of-charge is determined initially so as to compensate for a change in the threshold value resulting from the aging of the rechargeable battery.

The threshold value may be a lower limit of the state-of-charge of the rechargeable battery at which the rechargeable battery is permitted to supply to the electric rotating machine a degree of electric power required to run the vehicle.

Each of the rechargeable battery state-of-charge quantifying apparatuses, as described above, may also include determining means for determining a permissible lower limit voltage rechargeable battery when discharged. The calculator determines as the lower limit a minimum value of the state-of-charge of the rechargeable battery at which a terminal voltage at the rechargeable battery is greater than or equal to the permissible lower limit voltage when the rechargeable battery supplies to the electric rotating machine the electric power required to run the vehicle.

As the rechargeable battery ages, the internal resistance of the rechargeable battery is increased, which may cause the terminal voltage at the rechargeable battery when discharged to drop even when the state-of-charge and the electric power discharged remain unchanged. It is, therefore, essential to increase the lower limit of the state-of-charge with the aging of the rechargeable battery for determining the permissible lower limit voltage.

Each of the rechargeable battery state-of-charge quantifying apparatuses may also include an estimator which estimates an internal resistance of the rechargeable battery in a given cycle as an aging parameter representing a state of aging of the rechargeable battery. The calculator determines the lower limit at which the rechargeable battery is permitted to supply the electric power required to run the vehicle based on an input of the aging parameter.

As the rechargeable battery is aged, the internal resistance thereof usually increases, The internal resistance may, therefore, be used as a parameter in quantifying the state of aging of the rechargeable battery. The use of the internal resistance facilitates the simulation of a change in condition of the rechargeable battery when discharged.

The vehicle may be equipped with only the electric rotating machine as the drive source. In this case, the required electric power is electric power the rechargeable battery is required to supply to the electric rotating machine to meet a given acceleration performance of the vehicle.

When the vehicle is accelerated, the required amount of electric power or the level of electric power will increase, thus resulting in an increase in drop in terminal voltage at the rechargeable battery or in state-of-charge of the rechargeable battery. The use of the acceleration performance of the vehicle, therefore, enables the lower limit of the state-of-charge to be determined suitably.

The calculator may determine the lower limit based on a current temperature of the rechargeable battery.

The internal resistance of the rechargeable battery depends upon the temperature thereof. The behavior of the rechargeable battery when discharged, thus, changes with a change in temperature thereof. The lower limit of the state-of-charge of the rechargeable battery to ensure the acceleration performance of the vehicle, therefore, depends upon the temperature of the rechargeable battery. The rechargeable battery state-of-charge quantifying apparatus, thus, determines the lower limit as a function of the temperature of the rechargeable battery for compensating for a change in behavior of the rechargeable battery.

The vehicle may also be equipped with an internal combustion engine. The required electric power is electric power the rechargeable battery is required to supply to the electric rotating machine to start the internal combustion engine,

In the case where the electric rotating machine is of an electronically-controlled type for use in providing an initial torque to the internal combustion engine, the rechargeable battery state-of-charge quantifying apparatus calculates the lower limit of the state-of-charge of the rechargeable battery which ensures the starting of the internal combustion engine.

The calculator determines the lower limit based on a minimum temperature the rechargeable battery is expected to have.

The internal resistance of the rechargeable battery depends upon the temperature thereof. The behavior of the rechargeable battery when discharged, thus, changes with a change in temperature thereof. The behavior will be problematic as the temperature decreases. The rechargeable battery state-of-charge quantifying apparatus, therefore, calculates the lower limit of the state-of-charge as a function of the temperature of the rechargeable battery, thereby compensating for a change in state-of-charge depending upon the temperature of the rechargeable battery.

The rechargeable battery state-of-charge quantifying apparatus may also include a second calculator which calculates a value of the state-of-charge of the rechargeable battery which is greater by a given amount of energy than a minimum value of the state-of-charge of the rechargeable battery above which the rechargeable battery is permitted to produce the electric power the rechargeable battery is required to supply to the electric rotating machine as the lower limit of the state-of-charge at which only the electric rotating machine is permitted to produce the drive force for the vehicle which ensures the given traveling performance of the vehicle.

The rechargeable battery state-of-charge quantifying apparatus may also include OCV-to-SOC relation detei wining means for determining a relation between an open-circuit voltage (OCV) and the state-of-charge (SOC) of the rechargeable battery, first calculating means for calculating a total of a charged/discharged amount of electric energy to or from the rechargeable battery when the rechargeable battery is charged or discharged for a given period of time, second calculating means for calculating a change in the state-of-charge through the OCV-to-SOC relation based on a change in open-circuit voltage of the rechargeable battery arising from charging or discharging of the rechargeable battery for the given period of time, third calculating means for calculating a full electric charge (i.e., fully charged amount) in the rechargeable battery based on the change in the state-of-charge, as calculated by the second calculating means, and the total of the charged/discharged amount, as calculated by the first calculating means. The second calculator uses the full electric charge in calculating the value of the state-of-charge of the rechargeable battery which is greater by the given amount of energy than the minimum value of the state-of-charge of the rechargeable battery.

The full electric charge (i.e., the amount of electric charge when the rechargeable battery is fully charged) depends upon the aging of the rechargeable battery, The relation between the state-of-charge and the open-circuit voltage hardly changes with the aging of the rechargeable battery. Based on this fact, the rechargeable battery state-of-charge quantifying apparatus is designed to ensure accuracy in calculating the value of the state-of-charge of the rechargeable battery which is greater by the given amount of energy than the minimum value of the state-of-charge of the rechargeable battery.

The lower limit of the state-of-charge of the rechargeable battery above which the rechargeable battery is permitted to produce the electric power required to run the vehicle is a minimum value of the state-of-charge of the rechargeable battery at which the rechargeable battery is permitted to produce electric power for a given period of time which is required to run the vehicle.

The rechargeable battery state-of-charge quantifying apparatus may also include an informing device which, when an actual value of the state-of-charge reaches the lower limit, informs, for example, the driver of the vehicle of such an event. The informing device may indicate the degree to which the actual value of the state-of-charge is greater than the lower limit.

The rechargeable battery state-of-charge quantifying apparatus may also include an informing device which indicates the degree to which the actual value of the state-of-charge is greater than the lower limit of the state-of-charge at which only the electric rotating machine is permitted to produce the drive force for the vehicle which ensures the given traveling performance of the vehicle.

The informing device may be designed to visually indicate the degree to which the actual value of the state-of-charge is greater than the lower limit on a basis of the lower limit without showing a relation between the lower limit and a point at which the state-of-charge is zero. This brings the driver's attention to the lower limit.

The lower limit is a value of the state-of-charge of the rechargeable battery which satisfies a value of an output power of the electric rotating machine required to run the vehicle in the condition where a terminal voltage at the rechargeable battery is kept above a permissible lower limit voltage thereof when the rechargeable battery is being discharged. As the rechargeable battery is aged, the internal resistance thereof increases, thus resulting in a drop in terminal voltage at the rechargeable battery when discharged in the condition where the state-of-charge and the electric power discharged are constant. It is, therefore, essential to increase the lower limit of the state-of-charge with the aging of the rechargeable battery for determining the permissible lower limit voltage.

In the case where the vehicle is equipped with only the electric rotating machine, the lower limit is set to a minimum value of the state-of-charge of the rechargeable battery which satisfies a given acceleration performance of the vehicle. Specifically, when the vehicle is accelerated, the required amount of electric power or the electric power itself will increase, thus resulting in an increase in drop in terminal voltage at the rechargeable battery or in state-of-charge of the rechargeable battery. The use of the acceleration performance of the vehicle, therefore, enables the lower limit of the state-of-charge to be determined suitably.

The rechargeable battery state-of-charge quantifying apparatus may also include a travel limiter which limits traveling of the vehicle when a value of the state-of-charge of the rechargeable battery reaches the lower limit.

In the case where the vehicle is equipped with an internal combustion engine in addition to the electric rotating machine, the lower limit is set to a minimum of the state-of-charge of the rechargeable battery at which only the electric rotating machine is permitted to provide a drive force to ensure a given traveling perfoi ivance of the vehicle.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings;

FIG. 1 is a block diagram which shows a rechargeable battery state-of-charge quantifying apparatus according to the first embodiment;

FIG. 2 is a functional block diagram which shows an internal structure of a controller of the rechargeable battery state-of-charge quantifying apparatus of FIG. 1;

FIG. 3 is a flowchart of a program to executed by the controller of FIG. 2 to calculate a full electric charge of a rechargeable battery;

FIG. 4 is a flowchart of a program to be executed by the controller of FIG. 2 to calculate a state-of-charge of a rechargeable battery;

FIG. 5 is a flowchart of a program to be executed by the controller of FIG. 2 to calculate a state-of-charge lower limit of a rechargeable battery;

FIG. 6 is a flowchart of a program to be executed by the controller of FIG. 2 to calculate a state-of-charge threshold;

FIG. 7 is a view which demonstrates a change in terminal voltage at a rechargeable battery with aging thereof;

FIG. 8(a) is a view which demonstrates an available energy range of a rechargeable battery as provided by the rechargeable battery state-of-charge quantifying apparatus of FIG. 1;

FIG. 8(b) is a view which demonstrates a comparative example where a state-of-charge lower limit and a state-of-charge threshold are set to be high before a rechargeable battery ages for compensating for drops therein due to the aging of the rechargeable battery;

FIG. 9(a) is a view which demonstrates examples of how to display a state-of-charge of a rechargeable battery when the rechargeable battery is in mint condition;

FIG. 9(b) is a view which demonstrates examples of how to display a state-of-charge of a rechargeable battery when the rechargeable battery is in aged condition;

FIG. 10 is a block diagram which shows a rechargeable battery state-of-charge quantifying apparatus according to the second embodiment;

FIG. 11 is a flowchart of a program to be executed by the controller of FIG. 10 calculate a state-of-charge lower limit of a rechargeable battery; and

FIG. 12 is a view which demonstrates examples of how to display a state-of-charge of a rechargeable battery in the second embodiment.

### DESCRIPTION OF THE PREFERRED EMBODIMENTS

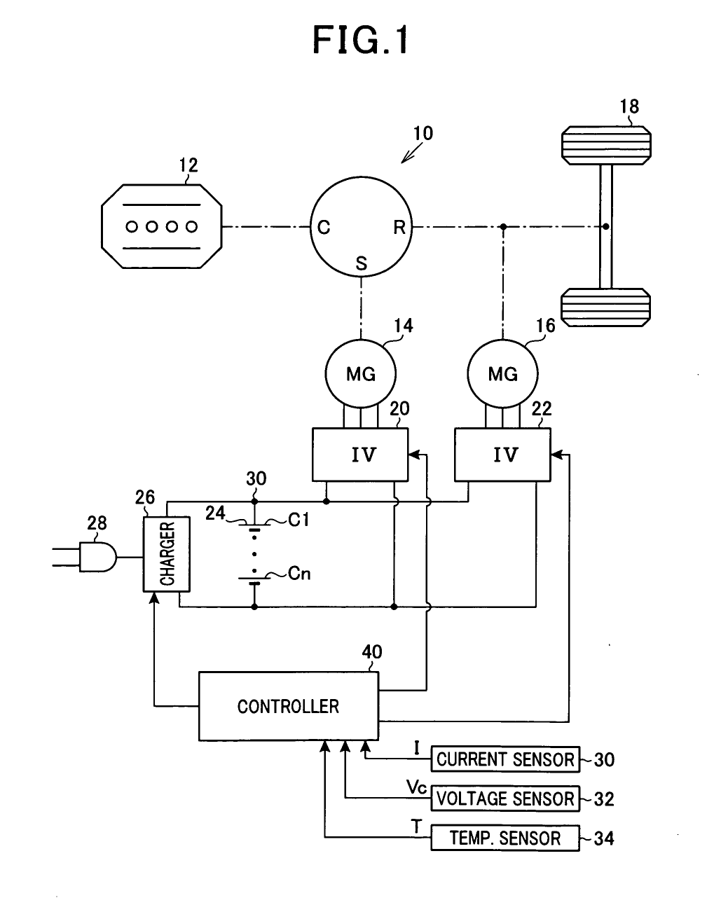

Referring to the drawings, wherein like reference numbers refer to like parts in several views, particularly to FIG. 1, there is shown a rechargeable battery state-of-charge quantifying apparatus mounted in a plug-in hybrid vehicle according to the first embodiment.

The plug-in hybrid vehicle, as illustrated in FIG. 1, is a parallel-series hybrid electric vehicle equipped with a power split device 10. The power split device 10 is equipped with a planetary gear set made up of a plurality of power split rotors (i.e., a sun gear S, a ring gear R, and a carrier q which interlock with each other to split output power or torque among an internal combustion engine 12, a motor-generator 14, a motor-generator 16, and driven wheels 14. Specifically, the ring gear R of the planetary gear set is connected mechanically to the motor-generator 16 and the driven wheels 18, The sun gear S is connected mechanically to the motor-generator 14. The carrier C is connected mechanically to the internal combustion engine 12.

The motor-generator 14 that is an electric rotating machine is coupled electrically to a high-voltage battery 24 through an inverter 20. Similarly, the motor-generator 16 that is an electric rotating machine is coupled electrically to the high-voltage battery 24 through an inverter 22. The high-voltage battery 24 is a lithium ion rechargeable battery which develops, for example, a high voltage of more than one hundred volts. The high-voltage battery 24 is implemented by a battery pack made up of a plurality of series-connected cells C1 to Cn.

The high-voltage battery 24 is a, rechargeable battery and joined to a battery charger 26, A plug 28 is connectable to the battery charger 26 to connect the high-voltage battery 24 to a commercial power source placed outside the vehicle to charge the high-voltage battery 24.

The charged/discharged amount I of electric current to or from the high-voltage battery 24 is measured by a. current sensor 30. The voltage at the high-voltage battery 24 is measured by a voltage sensor 32. The temperature T of the high-voltage battery 24 is measured by a temperature sensor 34. The voltage sensor 32 works to measure a cell voltage Vc, as appearing at each of the battery cells C1 to Cn.

The rechargeable battery state-of-charge quantifying apparatus also includes a controller 40 which operates the battery charger 26 to control the state-of-charge of the high-voltage battery 24 and also operates the inverters 20 and 22 to control operations of the motor-generators 14 and 16. The controller 40 monitors outputs of the current sensor 30, the voltage sensor 32, and the temperature sensor 34 to quantify the state-of-charge of the high-voltage battery 24. Specifically, the quantification is achieved using an equivalent circuit model of the battery cell Cj (j=1 to n). The equivalent circuit model may be realized, as taught in Japanese Patent First Publication No. 2007-147487 discussed in the introductory part of this application, by a series-connected combination of a power supply developing an electromotive force and a resistor, a capacitor coupled in parallel to the series-connected combination, and a resistor coupled in series with a parallel-connected combination of the series-connected combination and the capacitor. The internal resistance of the battery cell Cj, as will be referred to in the following discussion, is the resistance of the resistor connected in series with the above parallel-connected combination.

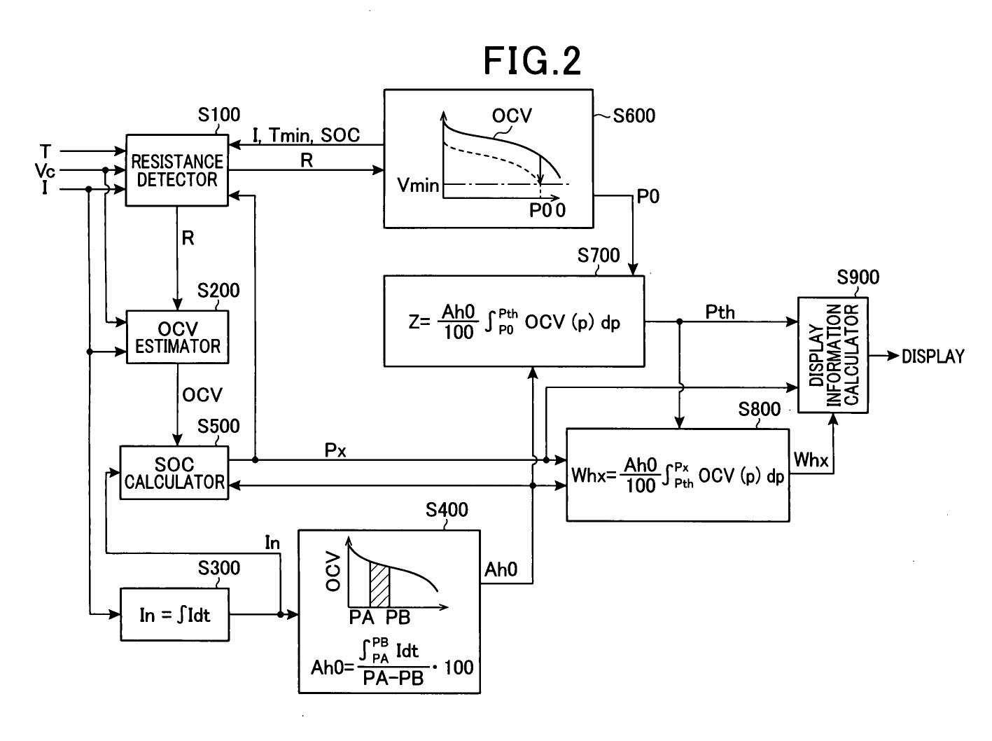

FIG. 2 is a function block diagram of the controller 40 which represents how to quantify the state-of-charge of the high-voltage battery 24.

The controller 40 includes an internal resistance detector S100, an open-circuit voltage estimator S200, a current totalizer S300, a full electric charge calculator S400, a state-of-charge calculator S500, a state-of-charge lower limit calculator S600, a state-of-charge threshold calculator S700, an energy amount estimator S800, and a display information calculator S900.

The internal resistance detector S100 samples the charged/discharged amount I of electric current to or from the high-voltage battery 24 and the cell voltage Vc to calculate the internal resistance R of the battery cell Cj based on the sampled values. This calculation may be made by taking a plurality of samples of values of the charged/discharged amount Iof current (which will also be referred to as a charged/discharged current I below) to or from the high-voltage battery 24 and the cell voltage Vc while an absolute value of the charged/discharged amount I is decreasing gradually when the inverter 20 and the battery charger 26 are in the off-state, and performing the multiple regression analysis on the sampled values. The latest value of the internal resistance R, as derived in this manner, is stored in relation to the temperature T of the high-voltage battery 24 and the current value of the state-of-charge of the high-voltage battery 24 (i.e., a ratio of an amount of electric energy now stored in high-voltage battery 24 to a maximum amount of electric energy which is permitted to be stored in the high-voltage battery 24 (i.e., a fully charged amount), in percentage). Specifically, the latest value of the internal resistance R is stored in a corresponding one of memory locations each having a memory address expressed by a value of the state-of-charge (SOC) and a value of the temperature T. Alternatively, the internal resistance detector S100 serves as a resistance calculator. Specifically, the internal resistance detector S100 calculates the value of the internal resistance R according to a mathematical formula representing a relation of the internal resistance R to the SOC and the temperature T and determines and stores a correction value required to bring the formula into agreement with a relation among latest values of the temperature T, the SOC, and the internal resistance R. The formula may be plotted on a map. The internal resistance R may be measured each time a travel distance of the vehicle reaches a given value or at a predetermined time interval.

The open-circuit voltage estimator S200 calculates an open-circuit voltage (OCV) of the battery cell Cf based on the cell voltage Vc, the internal resistance R, and the charged/discharged current I. This calculation is made based on the fact that the cell voltage Vc is the sum of the OCV and a voltage drop IR caused by the internal resistance R. However, when an output of the high-voltage battery 24 is changed, it is advisable that transient effects of polarization voltage on the cell voltage Vc be considered in calculating the cell voltage Vc.

The current totalizer S300 works as an integrator to add or sum a sequence of values of the charged/discharged current I. This operation is made in a cycle.

The full electric charge calculator S400 calculates a full electric charge Ah0 that is a full amount of electric charge (unit: ampere-hour) in the battery cell Cj based on a total of charged/discharged amount of current to or from the battery cell Cj when the OCV is changing. Specifically, the full electric charge Ah0 is determined by calculating a time-integrated value of an amount of current charged to or discharged from the high-voltage battery 24 for a period of time between when the SOC starts to change from a first SOC PA and when the SOC reaches a second SOC PB, and dividing the time-integrated value by [(PA-PB)%/100]. This calculation is to quantify the current value of the full electric charge Ah0 in the battery cell Cj accurately based on the fact that the full electric charge Ah0 usually changes with deterioration of the battery cell Cj. The relation between the OCV and the SOC hardly changes with the deterioration of the battery cell Cj. This means that it is possible to calculate a change in SOC (i.e., PA-PB) from a change in OCV, thus enabling the full change amount Ah0 to be derived accurately based on the total of charged/discharged amount when the SOC is changing.

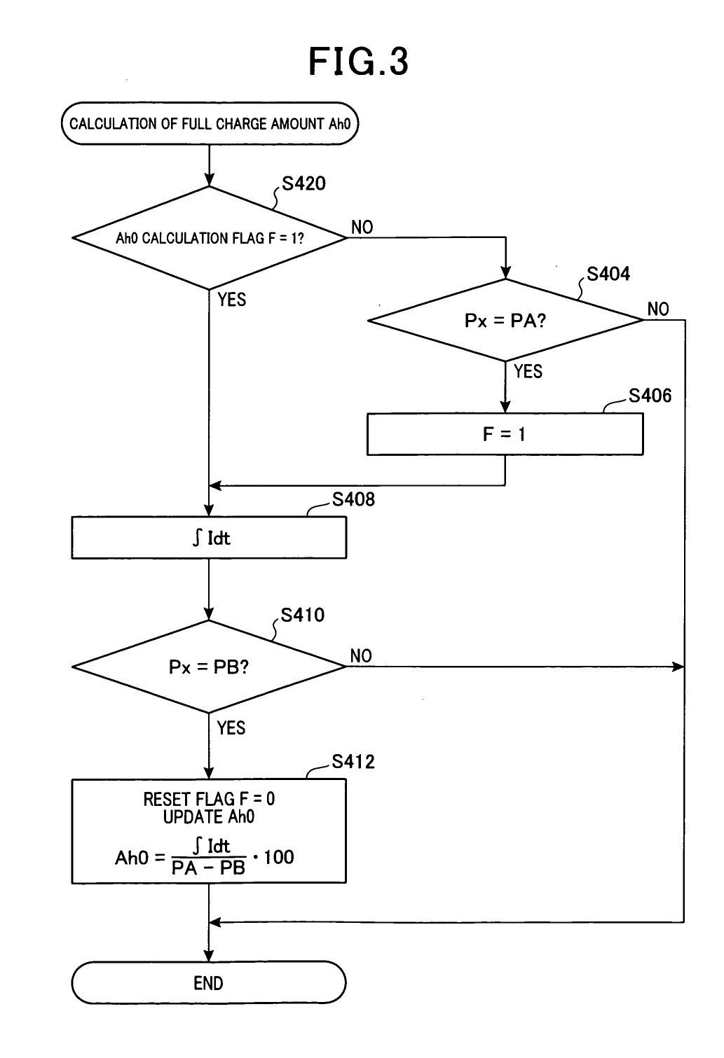

FIG. 3 is a flowchart of a sequence of logical steps or program to calculate the full electric charge Ah0, This program is to be executed at a given time interval.

After entering the program, the routine proceeds to step S420 wherein it is determined whether an Ah0 calculation flag F is true (i.e., one) or not. If a YES answer is obtained (i.e., F=1), it means that the full electric charge Ah0 is being calculated. Alternatively, if a NO answer is obtained (i.e., F=0), it means that the full electric charge Ah0 is not being calculated. The routine then proceeds to step S404 wherein a latest value of the SOC (which will also be referred to as a current SOC Px below) is in agreement with the first SOC PA or not. In other words, it is determined whether the time when operations for calculating the full electric charge Ah0 should start has been reached or not. If a YES answer is obtained, then the routine proceeds to step S406 wherein the Ah0 calculation flag F is set to one.

If a YES answer is obtained in step S402 or after step S406, the routine proceeds to step S408 wherein the sum of a sequence of values of the charged/discharged current I which have been sampled since the Ah0 calculation flag was changed to one is calculated. In other words, the value of the charged/discharged current I, as sampled in this program execution cycle, is added to the total of values of the charged/discharged current I, as derived one program execution cycle earlier. This summation is achieved by the current totalizer S300 of FIG. 2. After step S408, the routine proceeds to step S410 wherein it is detei mined whether the current SOC Px is in agreement with the first SOC PB (<PA) or not. In other words, it is determined whether the calculation of the full electric charge Ah0 is ready to start or not, that is, whether the time when the calculation of the full electric charge Ah0 should start has been reached or not. If a YES answer is obtained, then the routine proceeds to step S412 wherein the Ah0 calculation flag F is set to zero. The value of the full electric charge Ah0 is updated.

If a NO answer is obtained in step S404 or S410 or after step S412, the routine terminates.

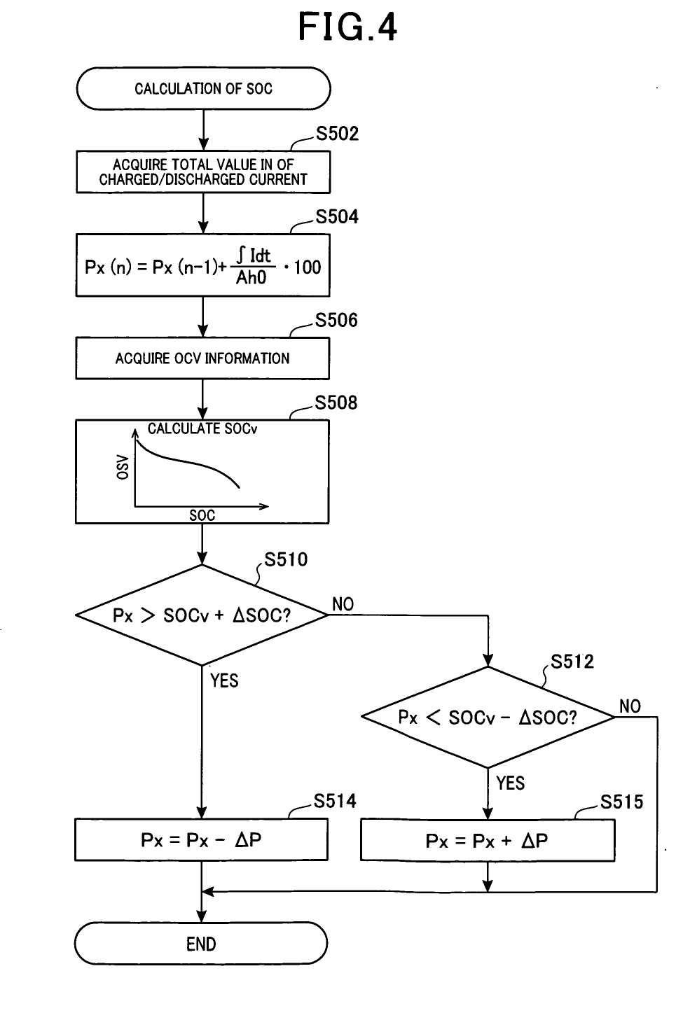

Referring back to FIG. 2, the state-of-charge calculator S500 calculates a current value of the state-of-charge of the battery cell Cj (i.e., the current SOC Px), FIG. 4 is a flowchart of a program to calculate the SOC of the battery cell Cj. The program is executed at a given time interval.

First, in step S502, the total value of the charged/discharged current I (which will be referred to as an integrated value In below), as derived by the current totalizer S300, is acquired. The integrated value In is derived through execution of the program of FIG. 4 in one cycle.

The routine proceeds to step S504 wherein the value calculated by dividing the integrated value In, as derived in step S504, by [Ah0/100], is added to the value of the current SOC Px), as obtained one program execution cycle earlier (which will also be referred t as a current SOC Px(n-1) below), to produce the latest value of the current SOC Px (which will be referred to as a current SOC Px(n) below).

The routine proceeds to step S506 wherein the open-circuit voltage (OCV) of the battery cell Cj, as derived by the open-circuit voltage estimator S200, is acquired. The routine proceeds to step 5508 wherein the SOC of the battery cell Cj (which will also be referred to as a SOCv below) is calculated based on a relation between OCV and SOC. This calculation may be achieved using a map listing the relation between OCV and SOC.

The routine proceeds to step S510 wherein it is determined whether the current SOC Px(n) is greater than the SOCv, as calculated based on the OCV, by a given amount ASOC or not. If a NO answer is obtained, then the routine proceeds to step S512 wherein it is determined whether the current SOC Px(n) is smaller than the SOCv, as calculated based on the OCV, by the amount ΔSOC or not, Steps S510 and S512 are to determine whether the SOC, as calculated based on the integrated value of the charged/discharged current I, needs to be corrected or not, In general, the SOC, as calculated by the integrated value of the charged/discharged current I, is susceptible to an error. The correctness of a value of the SOC is, therefore, evaluated in steps S510 and S512, if a YES answer is obtained in step S510, then the routine proceeds to step S514 wherein the current SOC Px(n) is decreased by a given amount ΔP. Alternatively, if a YES answer is obtained in step S512, then the routine proceeds to step S516 wherein the current SOC Px(n) is increased by the amount ΔP.

After step S514 or S516 or if a NO answer is obtained in step S512, the routine terminates.

Referring back to FIG. 2, the state-of-charge lower limit calculator S600 calculates a state-of-charge (which will be referred to as an SOC lower limit P0 below) of the battery cell Cj which is required to ensure starting of the engine 12 through the motor-generator 14 when the battery cell Cj is at a minimum voltage (which will be referred to as a lower limit voltage Vmin below) at a minimum temperature Tmin the high-voltage battery 24 would have. The calculation may be made by simulating changes in voltage at the terminal of the battery cell Cj when the high-voltage battery 24 is kept discharged for a given period of time for different values of the

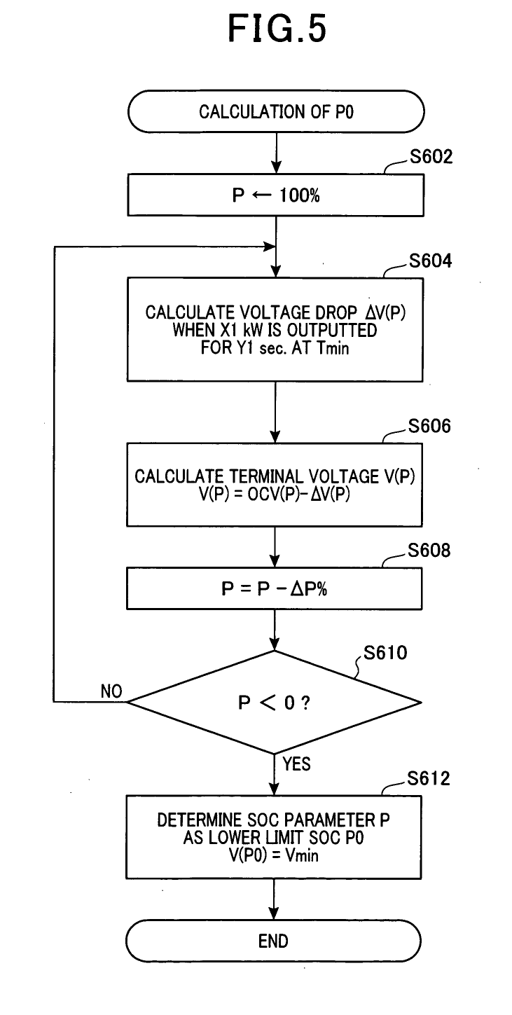

SOC at the minimum temperature Tmin. FIG. 5 is a flowchart of a program to calculate the SOC lower limit P0.

First, in step S602, a SOC parameter P is set to 100%. The routine proceeds to step S604 wherein a voltage drop ΔV(P) of the terminal voltage at the high-voltage battery 24 which is expected to occur when a required electric power X1 (kW) has continued to be outputted from the high-voltage battery 24 for a given period of time Y1 (e.g., several seconds) when the high-voltage battery 24 is at the lower limit voltage Vmin is calculated. This calculation is made using the latest value of the internal resistance R, as derived by the internal resistance detector S100. The charged/discharged current I used in calculating the internal resistance R is so determined that the value derived by multiplying the value, as calculated by subtracting the voltage drop ΔV(P)=RI from the value of the OCV corresponding to the SOC parameter P (which will also be referred to as OCV(P)), by the charged/discharged current I and the number n of the battery cells C1 to Cn will be equal to the power X1 required by the motor-generator 14. Specifically, the charged/discharged current I is so determined as to meet a relation of X1=(OCV(P)−RI)×I×n. The period of time Y1 is the length of time the high-voltage battery 24 is required by the motor-generator 14 to continue to output the power to start the engine 12. It is, therefore, advisable that the above simulation consider a change in SOC from a temporarily set value thereof which arises from the continuation of discharge of the high-voltage battery 24 for the period of time Y1 and a transitional behavior of the high-voltage battery 24. Note that the power X1 and the period of time Y1 are set to values needed to activate the motor-generator 14 to apply initial torque to the engine 12 to fire it up fully after the motor-generators 14 and 16 and the engine 12 are all stopped completely. The routine proceeds to step S606 wherein the tel veinal voltage V(P) that is the voltage appearing across the terminals of the high-voltage battery 24 when the required power X1 is being discharged from the high-voltage battery 24 is calculated by subtracting the voltage drop ΔV(P) from the OCV(P). The routine proceeds to step S608 wherein the SOC parameter P is decreased by a given amount ΔP %.

The routine proceeds to step S5608 wherein it is determined whether the SOC parameter P is smaller than zero or not. This determination is made to check whether the simulations on the voltage drop at the high-voltage battery 24 have been completed for all the preselected different values of the SOC of the high-voltage battery 24 or not. If a NO answer is obtained, then the routine returns back to step S604. Alternatively, if a YES answer is obtained, then the routine proceeds to step S612 wherein the SOC parameter P when the tel Lliinal voltage V(P) reaches the lower limit voltage Vmin is determined as the SOC lower limit P0.

After step S612, the routine terminates.

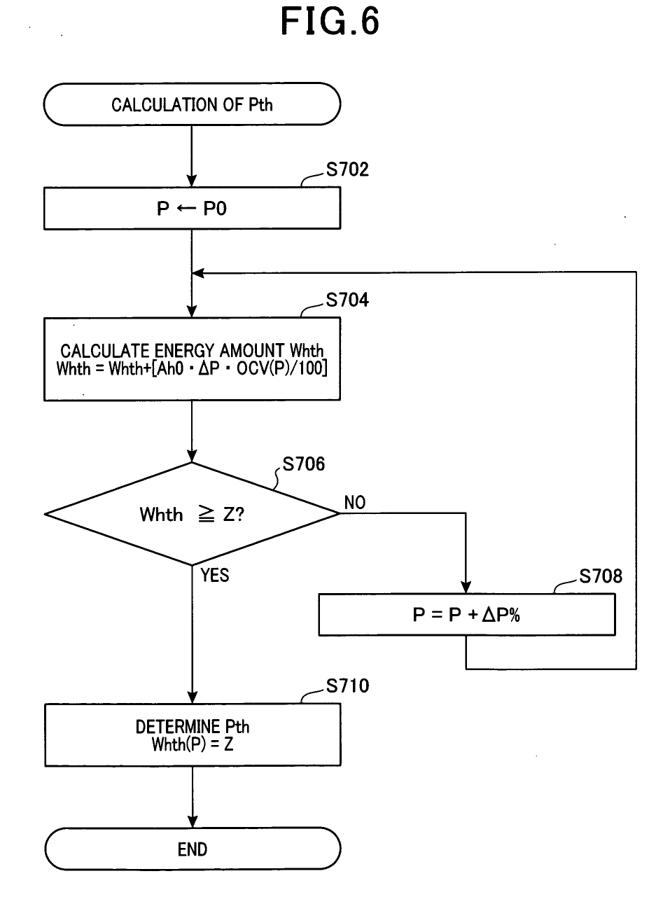

Referring back to FIG. 2, the state-of-charge threshold calculator S700 calculates an SOC threshold Pth for use as a point in switching from an EV (Electric Vehicle) travel mode to a hybrid travel mode of operation of the vehicle. The EV travel mode is one of travel modes of the vehicle in which only the motor-generator 16 is used as a drive source to output a drive torque to run the vehicle. The hybrid travel mode is one of the travel modes of the vehicle in which the output from the engine 12 is also used to run the vehicle. The SOC threshold Pth is preferably so determined as to be greater than the SOC lower limit P0 by a given amount Z. The amount Z is selected to be equivalent to the amount of energy in the high-voltage battery 24 which is expected to enable the vehicle to run without dropping below the SOC lower limit P0 in the hybrid travel mode switched from the EV travel mode. FIG. 6 is a flowchart of a program to calculate the SOC threshold Pth. The program is executed at a given time interval.

First, in step S702, the SOC parameter P is set to the SOC lower limit P0. The routine then proceeds to step S704 wherein an energy amount Whth that is the amount of electric energy between the SOC lower limit P0 and the SOC parameter P is calculated. Specifically, the SOC parameter P is, as described above, changed in units of the amount ΔP. Thus, the amount of electric energy between the SOC parameter P, as set one program execution cycle earlier, and the SOC parameter P plus the amount ΔP is added to the value of the energy amount Whth, as calculated one program execution cycle earlier. Specifically, the amount of energy discharged from the high-voltage battery 24 for a period of time when the SOC of the high-voltage battery 24 is changed from the SOC parameter P by the amount ΔP is expressed by [Ah0·ΔP/100]. The averaged value of the OCV during such an interval is expressed as OCV(P). The added amount of energy is, therefore, given by [Ah0·ΔP·OCV(P)/100].

The routine proceeds to step S706 wherein it is determined whether the energy amount Whth between the SOC lower limit P0 and the SOC parameter P is greater than or equal to the amount Z or not. If a NO answer is obtained, then the routine proceeds to step S708 wherein the SOC parameter P is increased by the amount ΔP. Alternatively, if a YES answer is obtained, then the routine proceeds to step S710 wherein the latest value of the SOC parameter P, as given in this program execution cycle (i.e., a previous value of P plus ΔP), is defined as the SOC threshold Pth.

Referring back to FIG. 2, the energy amount estimator S800 estimates an available energy amount Whx that is the amount of electric energy available between the SOC threshold Pth and the current SOC Px. This estimation is achieved in FIG. 6 by setting an initial value of the SOC parameter P to the SOC threshold Pth and performing the operation in step S704 until the SOC parameter P is smaller than the current SOC Px by the amount ΔP.

The display information calculator S900 calculates information to be displayed for the driver of the vehicle based on the current SOC Px, the SOC threshold Pth, and the available energy amount Whx. Specifically, the display information represents the degree to which the current SOC Px is greater than the SOC threshold Pth. The SOC threshold Pth and the current SOC Px to be displayed may be given by one of the battery cells C1 to Cn of the high-voltage battery 24 which is the greatest in internal resistance R or the smallest in the full electric charge Ah0. However, one of the battery cells C1 to Cn whose terminal voltage reaches the lower limit voltage Vmin earliest is not always one of the battery cells C1 to Cn whose full electric charge Ah0 is the smallest or internal resistance R is the greatest. Consequently, one of the battery cells C1 to Cn whose terminal voltage is predicted based on the full electric charge Ah0 and the internal resistance R thereof to reach the lower limit voltage Vmin earliest when the high-voltage battery 24 continues to be discharged is preferably selected to be displayed in the SOC threshold Pth and the SOC thereof.

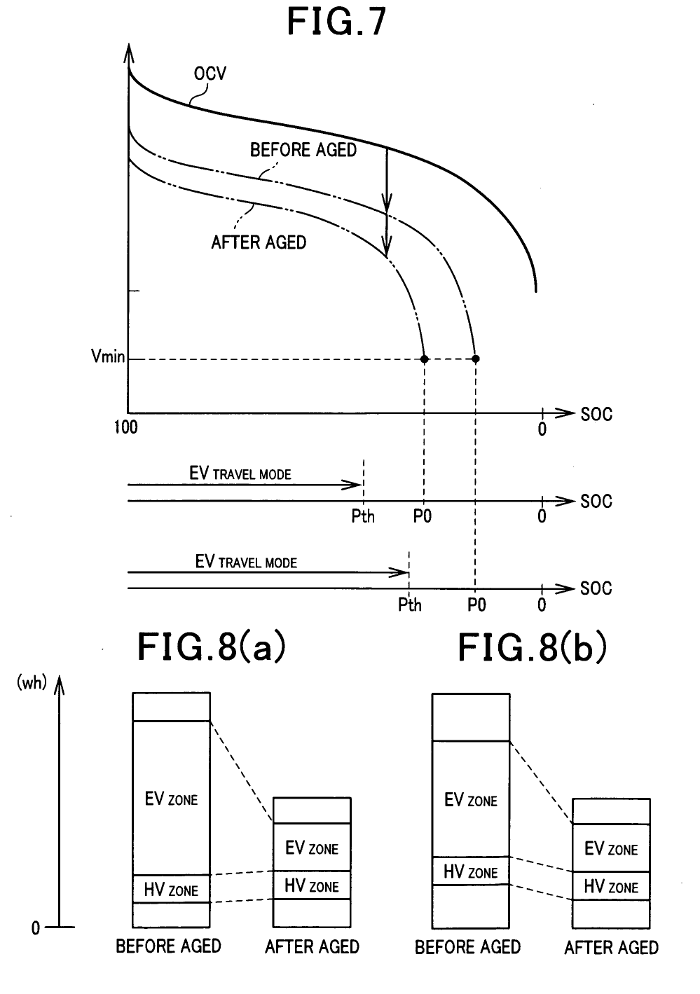

The determination of the SOC threshold Pth in the above manner permits the distance the vehicle can run in the EV travel mode to be increased. Specifically, the internal resistance of the high-voltage battery 24 usually increases with aging thereof. Thus, the terminal voltage at the high-voltage battery 24 when being discharged, as can be seen from FIG. 7, drops with the aging of the high-voltage battery 24. The SOC lower limit P0 and the SOC threshold Pth, therefore, need to be increased when the high-voltage battery 24 has been aged. If the SOC lower limit P0 and the SOC threshold Pth are determined to be high before the high-voltage battery 24 ages undesirably for compensating for drops therein resulting from the aging of the high-voltage battery 24, it will cause the travel mode of the vehicle to be switched undesirably early from the EV travel mode to the hybrid travel mode. In order to avoid this problem, the rechargeable battery state-of-charge quantifying apparatus of this embodiment, as described above, increases the SOC lower limit P0 and the SOC threshold Pth with the aging of the high-voltage battery 24, thereby maximizing the distance the vehicle is permitted to run in the EV travel mode, FIG. 8(a) demonstrates an energy available range of the high-voltage battery 24, as provided by the rechargeable battery state-of-charge quantifying apparatus of this embodiment. FIG. 8(b) demonstrates a comparative example where the SOC lower limit P0 and the SOC threshold Pth are set to be high before the high-voltage battery 24 ages undesirably for compensating for drops therein due to the aging of the high-voltage battery 24, In each graph of FIGS. 8(a) and 8(b), the length of the rectangular bar becomes short after the high-voltage battery 24 ages. This is because the amount of energy in the high-voltage battery 24 when charged fully drops with the aging thereof.

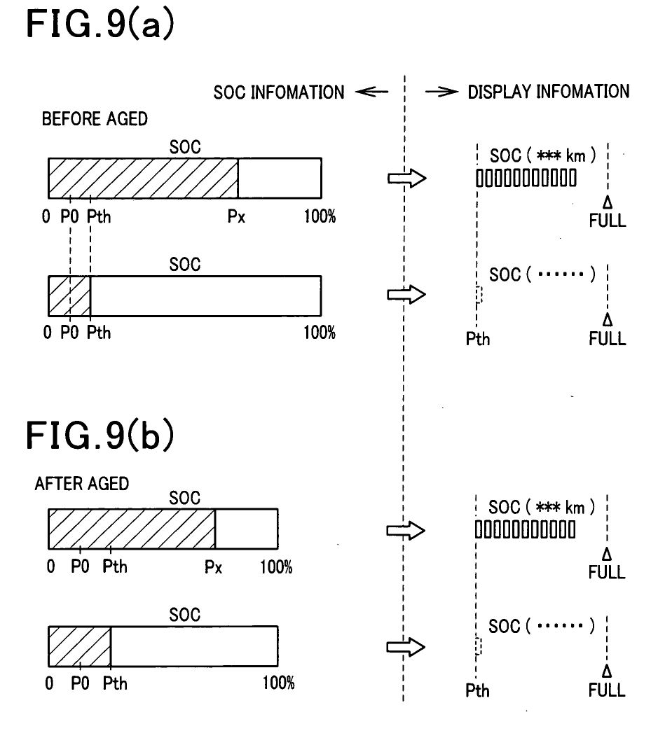

FIGS. 9(a) and 9(b) illustrate how to display the degree to which the current SOC Px is greater than the SOC threshold Pth in the rechargeable battery state-of-charge quantifying apparatus. The display information is indicated, for example, on an instrument panel of the vehicle. FIG. 9(a) demonstrates examples where the high-voltage battery 24 is in mint condition. FIG. 9(b) demonstrates examples where the high-voltage battery 24 is in aged condition.

The display information represents the amount of electric energy available from the high-voltage battery 24 until the SOC threshold Pth is reached, not the relation between the point at which the SOC of the high-voltage battery 24 is zero and the SOC threshold Pth. This enables the driver of the vehicle to know the degree to which the vehicle is permitted to run in the EV travel mode.

FIG. 9(b) illustrates SOC ranges between 0% to 100% to be shorter than those in FIG. 9(a). This means that the full electric charge Ah0 decreases with the aging of the high-voltage battery 24. The ranges in which the display information is to be indicated (i.e., between Pth and Full) are, as can be seen from the drawing, fixed regardless of the aging of the high-voltage battery 24, Therefore, the interval between the SOC threshold Pth and the current SOC Px on the display remains unchanged even when the amount of electric energy remaining in the high-voltage battery 24 changes with the aging of the high-voltage battery 24. Such an interval represents the available energy amount Whx. The display also indicates the distance (km) the vehicle is permitted to move in a given travel condition, for example, where the vehicle runs at a constant speed on a road which has a given resistance and a given inclination. The inclination may be zero.

The rechargeable battery state-of-charge quantifying apparatus of this embodiment offers the following advantages.

1) The SOC threshold Pth that is the lower limit of the SOC of the high-voltage battery 24 at which the vehicle is permitted to run in the EV travel mode is increased as the high-voltage battery 24 ages. This permits the distance the vehicle can run in the EV travel mode to be increased as compared with when the SOC threshold Pth is so predetermined as to compensate for a drop in the SOC threshold Pth resulting from the aging of the high-voltage battery 24.
2) The change in terminal voltage at the battery cell Cj when the high-voltage battery 24 is discharged is simulated for different values of the SOC of the battery cell Cj to determine the SOC lower limit P0. This enables the lower limit SCO P0 and the SOC threshold Pth to be determined desirably before the SOC of the battery cell Cj reaches the SOC lower limit P0 or the SOC threshold Pth.
3) The SOC lower limit P0 is determined as a function of the electric power required to be supplied to the motor-generator 14 for cranking the engine 12. This ensures the state of the high-voltage battery 24 needed to move the vehicle using the power of the engine 12.
4) The SOC lower limit P0 is also determined based on the minimum temperature Turin the high-voltage battery 24 would have. This keeps the terminal voltage at the battery cell Cj above the lower limit voltage Vmin, thus ensuring the stability in starting the engine 12 in the condition where the terminal voltage has a minimum level.
5) The SOC threshold Pth is so determined as to be greater than the SOC lower limit P0, thus permitting the operation of the vehicle to be switched to the hybrid travel mode when it is possible to run the vehicle through the engine 12 while the high-voltage battery 24 is being charged by the power of the engine 12.
6) The full electric charge Ah0 is determined based on a change in SOC of the high-voltage battery 24 and the total charged/discharged amount of electric energy when the high-voltage battery 24 is charged or discharged, thereby enabling the SOC threshold Pth to be calculated accurately as the SOC which is greater than the SOC lower limit P0 by a given amount.
7) The degree to which the current SOC Px is greater than the SOC threshold Pth is indicated on the display in the vehicle. This enables the driver of the vehicle to visually perceive the amount of energy in the high-voltage battery 24 which is available for moving the vehicle in the EV travel mode.
8) The current SOC Px is indicated on the display on the basis of the SOC threshold Pth without showing the relation between the point at which the SOC of the high-voltage battery 24 is zero and the SOC threshold Pth, thereby bringing the driver's attention to only information of interest to the driver.

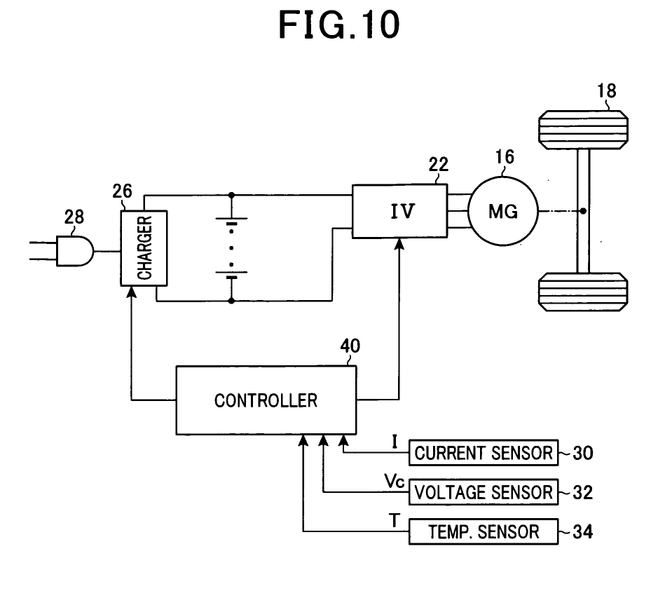

FIG. 10 shows a rechargeable battery state-of-charge quantifying apparatus according to the second embodiment of the invention. The same reference numbers as employed in FIG. 1 will refer to the same parts, and explanation thereof in detail will be omitted here.

The rechargeable battery state-of-charge quantifying apparatus of this embodiment is used with an electric vehicle equipped only with the motor-generator 16 working to drive the wheels 18.

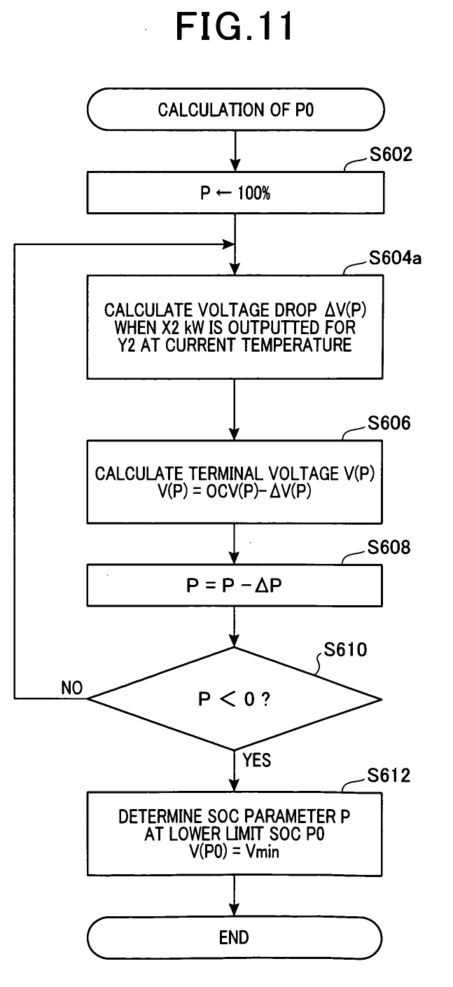

FIG. 11 is a flowchart of a program to be executed by the controller 40 of the second embodiment to calculate the SOC lower limit P0. The same step numbers as employed in FIG. 5 will refer to the same operations.

After, in step S602, the SOC parameter P is set to 100%, the routine then proceeds to step S604a wherein a voltage drop Δ V(P) of the terminal voltage at the high-voltage battery 24 (i.e., the battery cell Cj) when a required electric power X2 (kW) has continued to be outputted for a given period of time Y2 at a current temperature T of the high-voltage battery 24 is calculated. The amount of the power X2 being outputted for the period of time Y2 is the amount of power required for the high-voltage battery 24 to meet a maximum acceleration ability set in the vehicle. The required power X2 and the period of time Y2 are determined by a maximum output torque of the motor-generator 16 in specifications of the vehicle and a duration for which the maximum output torque is produced.

The rechargeable battery state-of-charge quantifying apparatus of this embodiment does not calculate the SOC threshold Pth. and defines the available energy amount Whx as the amount of electric energy available between the SOC lower limit Pth and the current OSC Px.

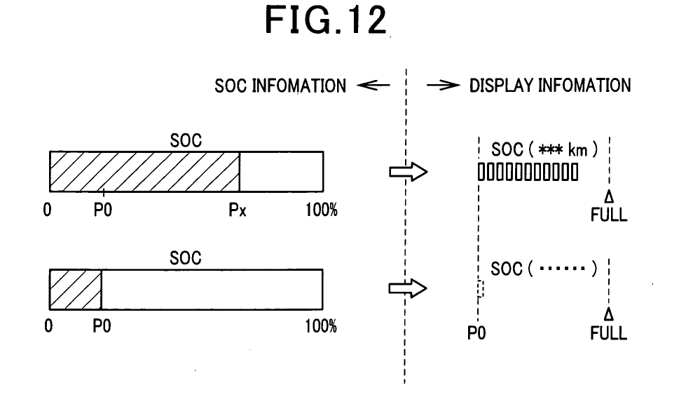

FIG. 12 illustrates the SOC of the high-voltage battery 24 indicated on the display of the vehicle in the second embodiment.

The display information is visually indicated by a lighted length of a one-dimensional indicator to represent the degree to which the current SOC Px is greater than the SOC lower limit P0 without showing the relation between the point at which the SOC of the high-voltage battery 24 is zero and the current SOC Px,

While the present invention has been disclosed in terms of the preferred embodiments in order to facilitate better understanding thereof, it should be appreciated that the invention can be embodied in various ways without departing from the principle of the invention.

The rechargeable battery state-of-charge quantifying apparatus may be modified as discussed below.

### Calculator

The rechargeable battery state-of-charge quantifying apparatus of the first embodiment (i.e., the calculator constructed in the controller 40) simulates a change in terminal voltage at the high-voltage battery 24 (i.e., the battery cell Cj) in conditions where the high-voltage battery 24 continues to be discharged to output a required power for a given period of time for preselected different values of the SOC (i.e., the open-circuit voltage (OCV)), but may simulate a change in output of the high-voltage battery 24 when discharged so as to keep the terminal voltage at the lower limit voltage Vmin for a given period of time for different values of the SOC. In this case, one of the values of the SOC when the required power is produced is defined as the SOC lower limit P0.

The calculator in the controller 40, as described above, simulates the state of the high-voltage battery 24 when started to be discharged from conditions where the high-voltage battery 24 has the respective different values of the SOC is, as described above, established in the controller 40, but may alternatively be designed to determine the open-circuit voltage V0 corresponding to the SOC lower limit P0 according to equations below. The equations ignore effects of a change in SOC (i.e., OCV) or polarization of the high-voltage battery 24 arising from the output of power for the given period of time.

V0−IR=Vmin

Vmin·I=X1

thus, Vmin·Vmin−Vmin·V0+R·X1=0

When the polarization of the high-voltage battery 24 is ignored, it is advisable that the lower limit voltage Vmin be shifted by a sufficient margin to a high-potential side.

The internal resistance R is used as a parameter indicating the degree of aging of the high-voltage battery 24, but a model simulating the electrochemical reaction of the high-voltage battery 24, as taught in, for example, Japanese Patent First Publication No. 2008-42960, may be employed to quantify the aging of the high-voltage battery 24. If the terminal voltage at the high-voltage battery 24 from which a required power has continued to be discharged for a given period of time can be known, the SOC lower limit P0 can be calculated.

### Temperature as Parameter to be Inputted to Calculator

The rechargeable battery state-of-charge quantifying apparatus of the first embodiment (i.e., the calculator constructed in the controller 40) uses a fixed value of the minimum temperature Tmin in calculating the SOC lower limit P0, but may alternatively employ a parameter associated with an area where the vehicle is used or season of the area. Specifically, when the fixed value is used as representing the temperature T of the high-voltage battery 24 in calculating the SOC lower limit P0, there is a possibility that the temperature the high-voltage battery 24 actually does not have is used. In order to avoid this problem, the value of the minimum temperature Trnin may be changed depending upon a preselected parameter associated with the area the vehicle is in and its reason, thereby minimizing the value of the SOC lower limit P0.

The rechargeable battery state-of-charge quantifying apparatus of the second embodiment uses the latest value of the temperature T in calculating the SOC lower limit P0, but may correct it depending upon the direction in which or the destination to which the vehicle is heading. Such correction is effective when an area the vehicle will arrive one or two hours later changes in ambient temperature greatly.

### Required Power as Parameter to be Inputted to Calculator

The power required to run the vehicle is not limited to the one, as described above. For instance, in the case where the vehicle is equipped with an engine starter which is powered by the high-voltage battery 12 and used only in starting the engine 12, the amount of power required by the starter may be used in calculating the voltage drop in the high-voltage battery 24. However, the inrush current usually flows through the starter when turned on, thus resulting in a maximum drop in voltage at the high-voltage battery 24. The time duration for which the required power is outputted may, therefore, be omitted from the calculation of the voltage drop.

The power required for the high-voltage battery 24 to produce torque through a single motor-generator to ensure the travelling performance of the vehicle is not limited to the one in the structure of the second embodiment. For instance, the power required to run the vehicle at a constant speed on a given road surface for a given period of time may be used in calculating the voltage drop in the high-voltage battery 24. A drop in SOC of the high-voltage battery 24 occurring in a given period of time is preferably considered. However, when the SOC lower limit P0 is set to a minimum value of the SOC where the terminal voltage at the high-voltage battery 24 is above the lower limit voltage Vmin, a greater degree of power is useful in determining the SOC lower limit P0 regardless of the length of the time duration for which the power is outputted. Accordingly, a maximum of the power needed to ensure the traveling performance (e.g., acceleration ability) of the vehicle is preferably used.

### SOC Lower Limit Increasing

The controller 40 needs not calculate the SOC lower limit P0. For example, a default value of the SOC lower limit P0 may be determined before the high-voltage battery 24 ages undesirably and corrected as a function of a change in internal resistance R resulting from the aging of the high-voltage battery 24. Specifically, the value of the SOC lower limit P0 is increased with an increase in internal resistance R. Note that a physical quantity other than the internal resistance R may be used as a parameter representing the aging of the high-voltage battery 24.

The parameter representing the aging of the high-voltage battery 24 is not limited to one, as derived in the model of the high-voltage battery 24. For instance, a time-integrated value of an absolute value of an output from the high-voltage battery 24 may alternatively be used. Alternatively, in the case where the vehicle is, like in the second embodiment, equipped with only a single motor-generator (i.e., the motor-generator 16), a time-integrated value of an absolute value of an output from the motor-generator or a travel distance of the vehicle may be used. In case of use of the travel distance, the SOC lower limit P0 is increased with an increase in total travel distance of the vehicle which represents an increase in aging of the high-voltage battery 24.

### SOC Threshold

The SOC threshold Pth needs not be set to the lower limit of the SOC of the high-voltage battery 24, but may alteAliatively be an upper limit thereof. Specifically, when the high-voltage battery 24 is being charged, the terminal voltage at the high-voltage battery 24 usually increases over the open-circuit voltage (OCV) thereat. In general, the terminal voltage has an upper limit voltage Vmax. The upper limit of the SOC of the high-voltage battery 24 which enables the Auotor-generator 16 to produce braking power required in the regenerative braking mode under condition where the terminal voltage is kept below the upper limit voltage Vmax may, therefore, be used in determining the SOC threshold Pth.

### Informing Device or Display

The degree to which the current SOC Px is greater than the SOC lower limit P0 or the SOC threshold Pth is, as described above, displayed in the form of one-dimensional visual information along with an indication of an available travel distance of the vehicle, but the available energy amount Whx may also be displayed.

The ends of the displayed range of the amount of energy available from the high-voltage battery 24 are, as discussed above, defined by the SOC lower limit P0 or the SOC threshold Pth and the full electric charge Ah0. In other words, the distance between the ends of the displayed range (i.e., the length of the display) is fixed regardless of a change in the available amount of energy with a change in the SOC lower limit P0, the SOC threshold Pth, or the full electric charge Ah0. The distance between the right and left ends of a lighted portion of the display (i.e., the length of lighted ones of indicator lamps (e.g., LEDs) may, however, be decreased with a decrease in the full electric charge Ah0 or an increase in the SOC lower limit P0 or the SOC threshold Pth while lighting the ends of the displayed range.

The amount of electric energy available from the high-voltage battery 24 may be represented by lighting the indicator lamps of the display regardless of a change in the SOC lower limit P0 or the full electric charge Ah0 without showing the point indicating the full electric charge Ah0.

The degree to which the current SOC Px is greater than the SOC lower limit P0 or the SOC threshold Pth is, as described above, indicated in the form of an interval between an indicator line representing the SOC lower limit P0 or the SOC threshold Pth and the end of the indication of the current SOC Px, but only the available travel distance may alternatively be displayed.

The rechargeable battery state-of-charge quantifying apparatus of the first embodiment may be designed to indicate the SOC lower limit P0 additionally on the display, as illustrated in FIGS. 9(a) and 9(b). This enables the driver to visually perceive where the current SOC Px is between the SOC lower limit P0 and the SOC threshold Pth and know an operating condition of the engine 12 in the HV travel mode.

One of the ends of the displayed range FIG. 12 is defined by the indicator line representing the SOC lower limit P0, but may be shifted from the SOC lower limit P0 by one of discrete rectangular indicator lamps to show a value of the SOC smaller than the SOC lower limit P0.

The range between the point at which the SOC is zero and the point at which the SOC is 100% may be displayed geometrically along with indications of the current SCO Px and the SOC lower limit P0 or the SOC threshold Pth.

The information device for indicating the above information to the driver may alternatively be implemented by any acoustic device. For instance, when the current SOC Px reaches the SOC lower limit P0 or the SOC threshold Pth, it may be informed the driver acoustically using an alarm.

### Determination of SOC Threshold Pth

The SOC threshold Pth may be set to the lower limit of the SOC of the high-voltage battery 24 which ensures the acceleration ability required by the vehicle using only the motor-generator 16.

### Travel Inhibitor

The controller 40 of the first embodiment works as a travel inhibitor to inhibit the vehicle from traveling using only the motor-generator 16 when the current SOC Px reaches the SOC threshold Pth, but the controller 40 of the second embodiment may be designed as a travel limiter to limit the torque to be outputted to the driven wheel 18 when the current SOC Px reaches the SOC lower limit P0.

### Secondary Battery Whose Soc is to be Qualified

The rechargeable battery state-of-charge quantifying apparatus of each of the first and second embodiments qualifies the SOC of each of all the battery cells C1 to Cn of the high-voltage battery 24, but may be designed to quantify the SOC of each of adjacent some of the battery cells C1 to Cn. The rechargeable battery state-of-charge quantifying apparatus may alternatively be designed to quantify the internal resistance of the high-voltage battery 24. In this case, the internal resistance R is a value dividing the internal resistance of the high-voltage battery by the number of the battery cells C1 to Cn. Thus, in order to keep the terminal voltage at each of the battery cells C1 to Cn above the lower limit voltage Vmin, the lower limit of the terminal voltage at the high-voltage battery 24 is preferably determined to be greater than the product of the lower limit voltage Vmin and the number n of the battery cells C1 to Cn by a given margin.

### Hybrid Vehicle

The hybrid vehicle with which the rechargeable battery state-of-charge quantifying apparatus is used may not necessarily be a parallel-series hybrid vehicle. For instance, the rechargeable battery state-of-charge quantifying apparatus may be installed in parallel hybrid vehicles engineered to be run only by the motor-generator 16. This also offers the same advantages, as described in the first embodiment.

The hybrid vehicle also might not be a vehicle in which the high-voltage battery 24 is rechargeable by an external power supply or designed to be run only by the motor-generator 16. For instance, the rechargeable battery state-of-charge quantifying apparatus may be installed in parallel hybrid vehicles in which an output shaft of the motor-generator 16 is coupled mechanically between the driven wheels 18 and the engine 12, and the motor-generator 16 is used only in assisting the operation of the engine 12. In case where this type of vehicle works to start the engine 12 through the motor-generator upon start of the vehicle, it is preferable to control the operation of the motor-generator 16 so that a permissible lower limit of the SOC of the high-voltage battery 24 is the SOC lower limit P0 at which the terminal voltage when the power required to start the engine 12 is outputted from the high-voltage battery 24 is greater than or equal to the lower limit voltage Vmin.

### Others

The SOC of the battery cell Cj is, as described above, calculated using the map listing the relation between OCV and SOC, but may alternatively be derived using an OCV-to-SOC mathematical formula.

The secondary battery (i.e., the high-voltage battery 24) may be a nickel hydride battery as well as a lithium ion battery.

The full electric charge Ah0 used in calculating the SOC threshold Pth is not limited to the one, as described in the first embodiment, but may be fixed to a default value. The default value may alternatively be decreased as the high-voltage battery 24 ages in relation to a parameter representing the degree of aging of the high-voltage battery 24. The parameter may be given by the length of time the high-voltage battery 24 has been used or a time-integrated value of an absolute value of a charged/discharged amount of energy in the high-voltage battery 24.

What is claimed is:

1. A rechargeable battery state-of-charge quantifying apparatus for use in a vehicle equipped with an electric rotating machine working as a drive source and a rechargeable battery serving to supply electric power to the electric rotating machine comprising:
quantifying means for quantifying a state-of-charge of the rechargeable battery, said quantifying means defining a minimum value of a state-of-charge of the rechargeable battery at which the rechargeable battery is permitted to produce a degree of electric power required to run the vehicle as a lower limit; and
increasing means for increasing the lower limit as the rechargeable battery ages.

2. A rechargeable battery state-of-charge quantifying apparatus as set forth in claim 1, wherein the lower limit is a minimum of the state-of-charge of the rechargeable battery at which the electric rotating machine is permitted to provide a drive force for the vehicle to ensure a given traveling perfox.wance of the vehicle.

3. A rechargeable battery state-of-charge quantifying apparatus as set forth in claim 1, further comprising an informing device which, when an actual value of the state-of-charge reaches the lower limit, informs such an event outside the rechargeable battery state-of-charge quantifying apparatus.

4. A rechargeable battery state-of-charge quantifying apparatus as set forth in claim 3, wherein the informing device indicates a degree to which the actual value of the state-of-charge is greater than the lower limit.

5. A rechargeable battery state-of-charge quantifying apparatus as set forth in claim 2, wherein the increasing means includes a calculator which calculates the lower limit of the rechargeable battery which produces the electric power required to run the vehicle based on a state of aging of the rechargeable battery.

6. A rechargeable battery state-of-charge quantifying apparatus as set forth in claim 5, wherein the calculator determines the lower limit by simulating a state of the rechargeable battery when the rechargeable battery is discharged from a value of the state-of-charge which is smaller than a current value of the state-of-charge.

7. A rechargeable battery state-of-charge quantifying apparatus as set forth in claim 6, wherein the calculator determines the lower limit by simulating a state of the rechargeable battery when the rechargeable battery is discharged in each of different values of the state-of-charge which are smaller than a current value of the state-of-charge.

8. A rechargeable battery state-of-charge quantifying apparatus as set forth in claim 5, further comprising determining means for determining a permissible lower limit voltage of the rechargeable battery when discharged, and wherein the calculator determines as the lower limit a minimum value of the state-of-charge of the rechargeable battery at which a terminal voltage at the rechargeable battery is greater than or equal to the peg uissibie lower limit voltage when the rechargeable battery supplies to the electric rotating machine the electric power required to run the vehicle.

9. A rechargeable battery state-of-charge quantifying apparatus as set forth in claim 5, further comprising an estimator which estimates an internal resistance of the rechargeable battery in a given cycle as an aging parameter representing a state of aging of the rechargeable battery, and wherein the calculator deteInaines the lower limit at which the rechargeable battery is permitted to supply the electric power required to run the vehicle based on an input of the aging parameter.

10. A rechargeable battery state-of-charge quantifying apparatus as set forth in claim 5, wherein the vehicle is equipped with only the electric rotating machine as the drive source, and wherein the required electric power is electric power the rechargeable battery is required to supply to the electric rotating machine to meet a given acceleration performance of the vehicle.

11. A rechargeable battery state-of-charge quantifying apparatus as set forth in claim 10, wherein the calculator calculates the lower limit based on a current temperature of the rechargeable battery.

12. A rechargeable battery state-of-charge quantifying apparatus as set forth in claim 5, wherein the vehicle is also equipped with an internal combustion engine, and wherein the required electric power is electric power the rechargeable battery is required to supply to the electric rotating machine to start the internal combustion engine.

13. A rechargeable battery state-of-charge quantifying apparatus as set forth in claim 12, wherein the calculator determines the lower limit based on a minimum temperature the rechargeable battery is expected to have.

14. A rechargeable battery state-of-charge quantifying apparatus as set forth in claim 12, further comprising a second calculator which calculates a value of the state-of-charge of the rechargeable battery which is greater by a given amount of energy than a minimum value of the state-of-charge of the rechargeable battery at which the rechargeable battery is permitted to produce the electric power the rechargeable battery is required to supply to the electric rotating machine as the lower limit of the state-of-charge at which only the electric rotating machine is permitted to produce the drive force for the vehicle which ensures the given traveling performance of the vehicle.

15. A rechargeable battery state-of-charge quantifying apparatus as set forth in claim 14, further comprising OCV-to-SOC relation determining means for determining a relation between an open-circuit voltage and the state-of-charge of the rechargeable battery, first calculating means for calculating a total of a charged/discharged amount of electric energy to or from the rechargeable battery when the rechargeable battery is charged or discharged for a given period of time, second calculating means for calculating a change in the state-of-charge through the OCV-to-SOC relation based on a change in open-circuit voltage of the rechargeable battery arising from charging or discharging of the rechargeable battery for the given period of time, third calculating means for calculating a full electric charge in the rechargeable battery based on the change in the state-of-charge, as calculated by the second calculating means, and the total of the charged/discharged amount, as calculated by the first calculating means, and wherein the second calculator uses the full electric charge in calculating the value of the state-of-charge of the rechargeable battery which is greater by the given amount of energy than the minimum value of the state-of-charge of the rechargeable battery.

16. A rechargeable battery state-of-charge quantifying apparatus as set forth in claim 5, wherein the lower limit of the state-of-charge of the rechargeable battery at which the rechargeable battery is permitted to produce the electric power required to run the vehicle is a minimum value of the state-of-charge of the rechargeable battery above which the rechargeable battery is permitted to produce electric power for a given period of time which is required to run the vehicle.

17. A rechargeable battery state-of-charge quantifying apparatus as set forth in claim 5, further comprising an infol wing device which, when an actual value of the state-of-charge reaches the lower limit, informs such an event outside the rechargeable battery state-of-charge quantifying apparatus.

18. A rechargeable battery state-of-charge quantifying apparatus as set forth in claim 17, wherein the informing device indicates a degree to which the actual value of the state-of-charge is greater than the lower limit.

19. A rechargeable battery state-of-charge quantifying apparatus as set forth in claim 14, further comprising an informing device which indicates a degree to which the actual value of the state-of-charge is greater than the lower limit of the state-of-charge at which only the electric rotating machine is per witted to produce the drive force for the vehicle which ensures the given traveling performance of the vehicle.

20. A rechargeable battery state-of-charge quantifying apparatus as set forth in claim 4, wherein the informing device is designed to visually indicate the degree to which the actual value of the state-of-charge is greater than the lower limit on a basis of the lower limit without showing a relation between the lower limit and a point at which the state-of-charge is zero.

21. A rechargeable battery state-of-charge quantifying apparatus as set forth in claim 1, wherein the lower limit is a value of the state-of-charge of the rechargeable battery which satisfies a value of an output power of the electric rotating machine required to run the vehicle in a condition where a terminal voltage at the rechargeable battery is kept above a permissible lower limit voltage thereof when the rechargeable battery is being discharged.

22. A rechargeable battery state-of-charge quantifying apparatus as set forth in claim 1, wherein the vehicle is equipped with only the electric rotating machine, and wherein the lower limit is a minimum value of the state-of-charge of the rechargeable battery which satisfies a given acceleration performance of the vehicle.

23. A rechargeable battery state-of-charge quantifying apparatus as set forth in claim 1, further comprising a travel limiter which limits traveling of the vehicle when a value of the state-of-charge of the rechargeable battery reaches the lower limit.

24. A rechargeable battery state-of-charge quantifying apparatus as set forth in claim 23, wherein the vehicle is also equipped with an internal combustion engine, and wherein the lower limit is a minimum of the state-of-charge of the rechargeable battery at which only the electric rotating machine is permitted to provide a drive force to ensure a given traveling performance of the vehicle.

25. A rechargeable battery state-of-charge quantifying apparatus for use in a vehicle equipped with an electric rotating machine working as a drive source and a rechargeable battery serving to supply electric power to the electric rotating machine comprising:
quantifying means for quantifying a state-of-charge of the rechargeable battery, said quantifying means defining a minimum value of the state-of-charge of the rechargeable battery above which the rechargeable battery is permitted to produce a degree of electric power required to run the vehicle as a lower limit; and
changing means for changing the lower limit as a function of a temperature of the rechargeable battery.

26. A rechargeable battery state-of-charge quantifying apparatus as set forth in claim 25, further comprising an informing device which, when an actual value of the state-of-charge reaches the lower limit, infaiins such an event outside the rechargeable battery state-of-charge quantifying apparatus.

27. A rechargeable battery state-of-charge quantifying apparatus as set forth in claim 26, wherein the informing device indicates a degree to which the actual value of the state-of-charge is greater than the lower limit.

28. A rechargeable battery state-of-charge quantifying apparatus as set forth in claim 27, wherein the informing device is designed to visually indicate the degree to which the actual value of the state-of-charge is greater than the lower limit on a basis of the lower limit without showing a relation between the lower limit and a point at which the state-of-charge is zero.

29. A rechargeable battery state-of-charge quantifying apparatus as set forth in claim 25, wherein the lower limit is a value of the state-of-charge of the rechargeable battery which satisfies a value of an output power of the electric rotating machine required to run the vehicle in a condition where a terminal voltage at the rechargeable battery is kept above a permissible lower limit voltage thereof when the rechargeable battery is being discharged.

30. A rechargeable battery state-of-charge quantifying apparatus as set forth in claim 29, wherein the vehicle is equipped with only the electric rotating machine, and wherein the lower limit is a minimum value of the state-of-charge of the rechargeable battery which satisfies a given acceleration performance of the vehicle,

31. A rechargeable battery state-of-charge quantifying apparatus as set forth in claim 29, further comprising a travel limiter which limits traveling of the vehicle when a value of the state-of-charge of the rechargeable battery reaches the lower limit.

32. A rechargeable battery state-of-charge quantifying apparatus as set forth in claim 31, wherein the vehicle is also equipped with an internal combustion engine, and wherein the lower limit is a minimum of the state-of-charge of the rechargeable battery at which only the electric rotating machine is permitted to provide a drive force to ensure a given traveling performance of the vehicle.

33. A rechargeable battery state-of-charge quantifying apparatus for use in a vehicle equipped with an electric rotating machine working as a drive source and a rechargeable battery serving to supply electric power to the electric rotating machine comprising:
quantifying means for quantifying a state-of-charge of the rechargeable battery; and
a calculator which simulates a state of the rechargeable battery when the rechargeable battery is charged or discharged from a value of the state-of-charge which is temporarily set to be different from a current value of the state-of-charge based on a state of aging of the rechargeable battery to calculate a threshold value of the state-of-charge required to run the vehicle.

34. A rechargeable battery state-of-charge quantifying apparatus as set forth in claim 33, wherein the threshold value is a lower limit of the state-of-charge of the rechargeable battery at which the rechargeable battery is permitted to supply to the electric rotating machine a degree of electric power required to run the vehicle.

35. A rechargeable battery state-of-charge quantifying apparatus as set forth in claim 34, further comprising determining means for determining a permissible lower limit voltage of the rechargeable battery when discharged, and wherein the calculator determines as the lower limit a minimum value of the state-of-charge of the rechargeable battery at which a terminal voltage at the rechargeable battery is greater than or equal to the permissible lower limit voltage when the rechargeable battery supplies to the electric rotating machine the electric power required to run, the vehicle.

36. A rechargeable battery state-of-charge quantifying apparatus as set forth in claim 34, further comprising an estimator which estimates an internal resistance of the rechargeable battery in a given cycle as an aging parameter representing a state of aging of the rechargeable battery, and wherein the calculator determines the lower limit above which the rechargeable battery is permitted to supply the electric power required to run the vehicle based on an input of the aging parameter.

37. A rechargeable battery state-of-charge quantifying apparatus as set forth in claim 34, wherein the vehicle is equipped with only the electric rotating machine as the drive source, and wherein the required electric power is electric power the rechargeable battery is required to supply to the electric rotating machine to meet a given acceleration performance of the vehicle.

38. A rechargeable battery state-of-charge quantifying apparatus as set forth in claim 37, wherein the calculator calculates the lower limit based on a current temperature of the rechargeable battery.

39. A rechargeable battery state-of-charge quantifying apparatus as set forth in claim 34, wherein the vehicle is also equipped with an internal combustion engine, and wherein the required electric power is electric power the rechargeable battery is required to supply to the electric rotating machine to start the internal combustion engine.

40. A rechargeable battery state-of-charge quantifying apparatus as set forth in claim 39, wherein the calculator determines the lower limit based on a minimum temperature the rechargeable battery is expected to have.

41. A rechargeable battery state-of-charge quantifying apparatus as set forth in claim 39, further comprising a second calculator which calculates a. value of the state-of-charge of the rechargeable battery which is greater by a given amount of energy than a minimum value of the state-of-charge of the rechargeable battery at which the rechargeable battery is pei uiitted to produce the electric power the rechargeable battery is required to supply to the electric rotating machine as the lower limit of the state-of-charge at which only the electric rotating machine is permitted to produce the drive force for the vehicle which ensures the given traveling performance of the vehicle.

42. A rechargeable battery state-of-charge quantifying apparatus as set forth in claim 41, further comprising OCV-to-SOC relation determining means for determining a relation between an open-circuit voltage and the state-of-charge of the rechargeable battery, first calculating means for calculating a total of a charged/discharged amount of electric energy to or from the rechargeable battery when the rechargeable battery is charged or discharged for a given period of time, second calculating means for calculating a change in the state-of-charge through the OCV-to-SOC relation based on a change in open-circuit voltage of the rechargeable battery arising from charging or discharging of the rechargeable battery for the given period of time, third calculating means for calculating a full electric charge in the rechargeable battery based on the change in the state-of-charge, as calculated by the second calculating means, and the total of the charged/discharged amount, as calculated by the first calculating means, and wherein the second calculator uses the full electric charge in calculating the value of the state-of-charge of the rechargeable battery which is greater by the given amount of energy than the minimum value of the state-of-charge of the rechargeable battery.

43. A rechargeable battery state-of-charge quantifying apparatus as set forth in claim 34, wherein the lower limit of the state-of-charge of the rechargeable battery at which the rechargeable battery is permitted to produce the electric power required to run the vehicle is a minimum value of the state-of-charge of the rechargeable battery above which the rechargeable battery is permitted to produce electric power for a given period of time which is required to run the vehicle.

44. A rechargeable battery state-of-charge quantifying apparatus as set forth in claim 34, further comprising an informing device which, when an actual value of the state-of-charge reaches the lower limit, informs such an event outside the rechargeable battery state-of-charge quantifying apparatus.

45. A rechargeable battery state-of-charge quantifying apparatus as set forth in claim 44, wherein the informing device indicates a degree to which the actual value of the state-of-charge is greater than the lower limit.

46. A rechargeable battery state-of-charge quantifying apparatus as set forth in claim 41, further comprising an informing device which indicates a degree to which the actual value of the state-of-charge is greater than the lower limit of the state-of-charge at which the electric rotating machine is permitted solely to produce the drive force for the vehicle which ensures the given traveling performance of the vehicle.

47. A rechargeable battery state-of-charge quantifying apparatus as set forth in claim 44, wherein the informing device is designed to visually indicate the degree to which the actual value of the state-of-charge is greater than the lower limit on a basis of the lower limit without showing a relation between the lower limit and a point at which the state-of-charge is zero.
